(19) United States
(12) Patent Application Publication
(10) Pub. No.: US 2002/0152700 A1
(43) Pub. Date: Oct. 24, 2002

(54) Method and device for joining timber I-beams

(76) Inventor: Roger Smith, Bury St Edmunds (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/116,150

(22) Filed: Apr. 4, 2002

(30) Foreign Application Priority Data
Apr. 21, 2001 (GB) 0109968.8
May 14, 2001 (GB) 0111688.8

(51) Int. Cl. E04B 1/00; E04B 5/00; E04B 7/00; E06B 3/54; E04B 9/00

(52) U.S. Cl. 52/289; 52/474

(57) ABSTRACT

A method is described for joining the end of a first timber I-beam to the side of a second similar timber I-beam in wherein the end of the web of the first I-beam is fitted between the two side cheeks of a rigid channel member which is secured to the web by means of through fastenings such as bolts. The bridging section of the channel member has at least one stud protruding therefrom in line with the web of the I-beam to which it is secured, for securing to the web of the second transverse I-beam. A hole is formed in the web of the second I-beam through which the or each stud can pass, and the two beams are joined by fitting a closure member to the protruding end of the stud. The stud may be smooth and the closure member in the form of a push-fit washer, or may have a series of annular ridges over which the closure can be forced until it is trapped between the web and one of the ridges or more preferably the stud is threaded and the closure is a nut, typically a so-called lock nut. An alternative design of joining member comprises two parallel spaced apart plates having re-entrant bends which are welded or otherwise secured back to back so as to join the two plates into an integral unit, and beyond the re-entrant regions the plates are bent outwardly to form two aligned flanges for abutting the web of the second I-beam, and for securing thereto. In this design the re-entrant regions bridge the gap between the web of the second I-beam and the end of the web of the first, so that it is unnecessary to cut back the flanges of the first I-beam to achieve a snug fit.

### FIELD OF INVENTION

This invention concerns a method and device whereby a reliable butt-joint can be formed between the end of one timber I-beam and the side of a second similar timber I-beam

### BACKGROUND TO THE INVENTION

Timber I-beams are used in the construction industry as an alternative to solid timber beams. The I-beams comprise a thin vertical web typically made from oriental strand board and top and bottom chord members made from solid timber or laminated timber. The I-beam section is more structurally efficient than a solid rectangular section and can be made to larger dimensions than is available in solid timber.

These beams are used as a direct replacement for solid timber and in that event are supplied to site as individual components for assembly on site by carpenters.

The assembly details are very similar to those used for solid timber comprising mainly nails or screws for fixing one I-beam to another and with the use of metal joist hangers for load bearing construction.

The use of nails, screws and metal joist hangers when joining such beams to form for large prefabricated components has been found to be inappropriate due to the loads imposed during handling and lifting. These loads are different from those encountered by the beams when joined in situ. Furthermore, I-beam junctions using metal joist hangers often require the web members to be packed locally with timber packers to increase the web region to the same width as the upper and lower rails to form a full rectangular section. This facilitates hanger fixing but is labour intensive and requires skill to achieve a satisfactory result.

It is an object of the present invention to provide an improved method for butt-joining two such timber I-beams to allow for prefabrication of flooring panels in particular. This will allow individual floor beams, typically timber I-beams in the main and floor sheeting to be made up into larger prefabricated floor decks and delivered to site for lifting into position by crane.

### SUMMARY OF THE INVENTION

According to the present invention a method of joining one end of a first timber I-beam to the side face of a transversely extending second similar timber I-beam, comprises the steps of fitting the web at the said one end of the first I-beam between two parallel spaced apart side cheeks of a rigid channel member, securing the channel member to the first I-beam web by means of at least one through fastening, forming a hole in the web of the second I-beam to receive a securing member adapted to join the channel member to the second I-beam, fitting into the hole in the web of the second I-beam a dished shear ring so as to be a tight fit therein, the shear ring having a central opening through which the securing member is to protrude, positioning the second I-beam relative to the channel member whereby a securing member can be pushed through the shear ring in the hole in the second I-beam so that an end thereof protrudes beyond the shear ring, and securing the two beams together by fitting a closure member to the protruding end of the securing member to clamp the shear ring to the web of the second beam and to the rear of the channel member attached to the web of the first beam, whereby the second I-beam web is held tightly against the channel member.

The channel member may comprise a bridging section which will abut the face of the second beam, and the securing means may comprise at least one stud protruding therefrom.

The or each stud may extend from the channel member in line with the web of the first I-beam.

The stud may be smooth and the closure device in the form of a push-fit washer such as a Circlip (Reg. Trademark).

Alternatively the or each stud may be formed with a plurality of annular flanges and a resiliently deformable washer push-fitted onto the stud, over the flanges until the web is held tightly against the rear of the base of the channel attached to the web of the first beam, with the washer held captive between one of the flanges and the web, and the flanges may be of triangular cross section so as to present a so-called fir-tree fastening.

Preferably however the or each stud is formed with a screw thread and the closure is a nut which may be a locking nut, with a washer sandwiched between it and the web of the second beam, if desired, and the joint is formed by screwing the nut onto the stud, until the web is tightly sandwiched between the nut (and washer if fitted) and the rear of the channel member attached to the web of the first beam.

The load bearing capacity of a joint formed in accordance with the invention is increased relative to what it would otherwise be, by employing the dished shear ring. The latter is preferably fitted by enlarging the opening in the web of the second beam which is to receive the stud, and fitting into the enlarged opening the dished shear ring so as to be a tight fit therein. The stud protrudes through the central opening in the shear ring and the engagement of the closure device on the stud serves to clamp the shear ring to the web of the second beam and to the rear of the channel member attached to the web of the first beam.

The closure member may be formed from metal or a rigid plastics material or from a metal reinforced plastics combination, or a composite such as GRP.

The stud or studs and the closures are typically formed from metal but may be formed from a rigid plastics material or a metal reinforced plastics combination.

The shear ring may be formed from rigid plastics or metal or GRP or a metal reinforced plastics configuration.

Where the channel member includes a bridging section which is to abut the face of the web of the second I-beam, the fit between the end of the first beam and the face of the second beam can be improved if the upper and lower rails (or flanges) of the first beam are cut back by an amount commensurate with the overhang of the corresponding rails (flanges) on the second beam relative to the web of the latter (less the thickness of the bridging base of the channel member), so that the web of the first beam extends beyond the end faces of the upper and lower rails (flanges) thereof.

In an alternative arrangement of channel member the two parallel plates forming the side cheeks which are to be secured to the web of the first beam are bent to form re-entrant regions beyond the end of the web of the first beam when fitted thereto, and beyond the re-entrant regions extend laterally to form oppositely directed fixing flanges which can be bolted to the web of the second beam (or may include integral studs for passing though the web of the second beam), the re-entrant regions being secured as by welding, back to back and serving to bridge the gap created by the overhang of the flanges of the second beam.

Preferably the side cheeks of the channel member extend over substantially the whole height of the web of the first beam so that the channel member is a snug fit between the upper and lower rails (flanges) of the first beam.

Preferably the bridging section of the one arrangement and the fixing flanges of the alternative arrangement extend over substantially the whole height of the web of the second beam so as to be a snug fit between the upper and lower rails (flanges) thereof.

Preferably the side cheeks of the channel member are formed with pairs of aligned holes and similar holes are formed in the web of the first I-beam, to allow bolts to be pushed through the hole in the end of the web and the two aligned holes on either side of the side cheeks of the channel member.

If desired the holes in the webs may be made slightly oversize and lined with a rigid cylindrical insert within which the bolt or stud is a close fit, to increase the load bearing characteristics of the joint.

The invention will now be described by way of example with reference to the accompanying drawings in which:

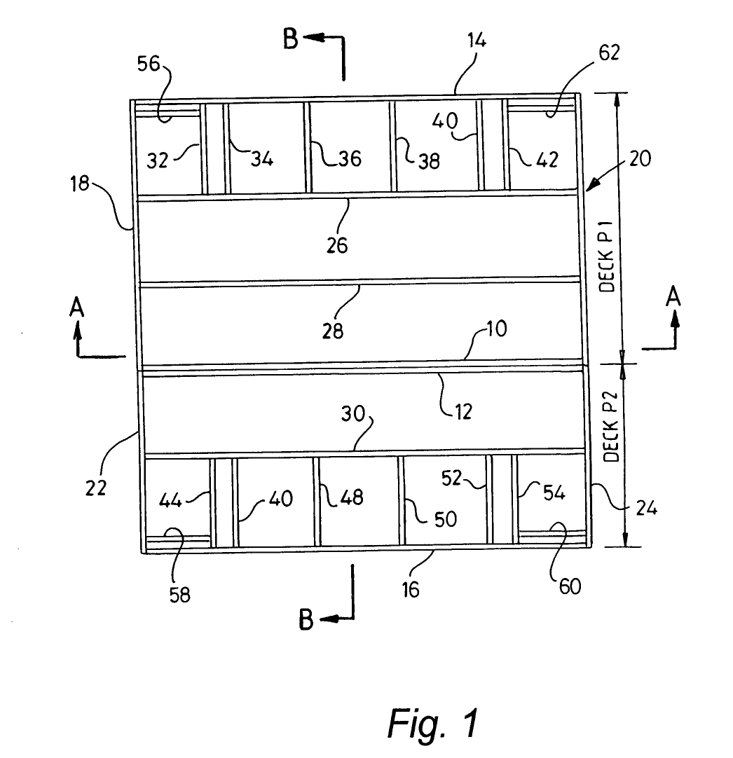

FIG. 1 is an exploded perpendicular view of an I-beam to I-beam fixing embodying the invention,

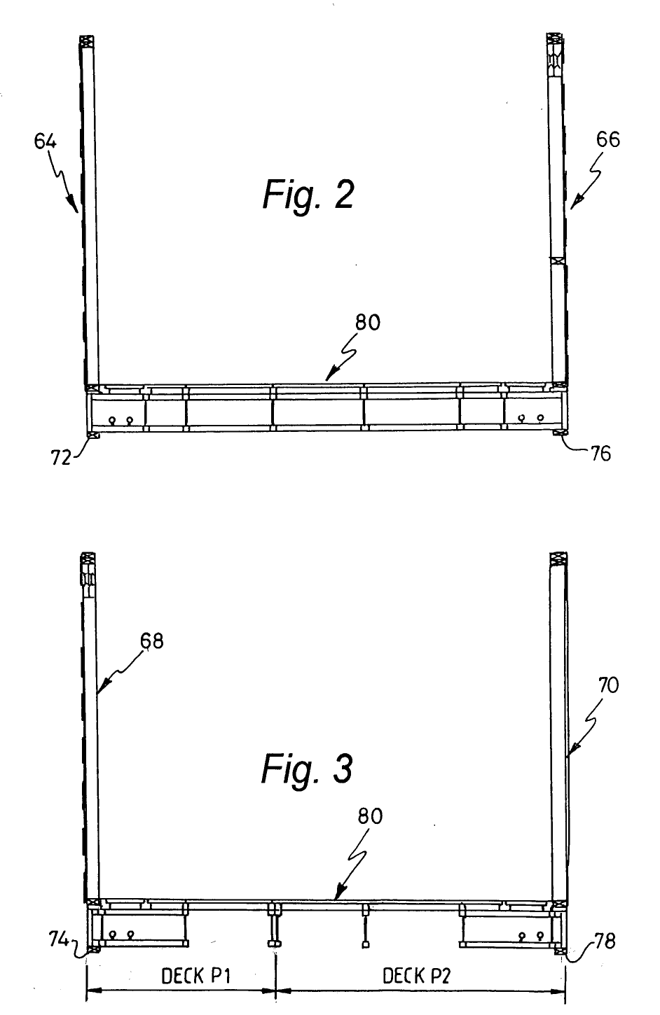

FIG. 2 is a cross-section from above of the I-beam to I-beam assembly, using the fixing of FIG. 1,

FIG. 3 is an elevation partially in cross-section of a modification to the web of the transverse I-beam to strenthen the joint between the fixing and the I-beam web,

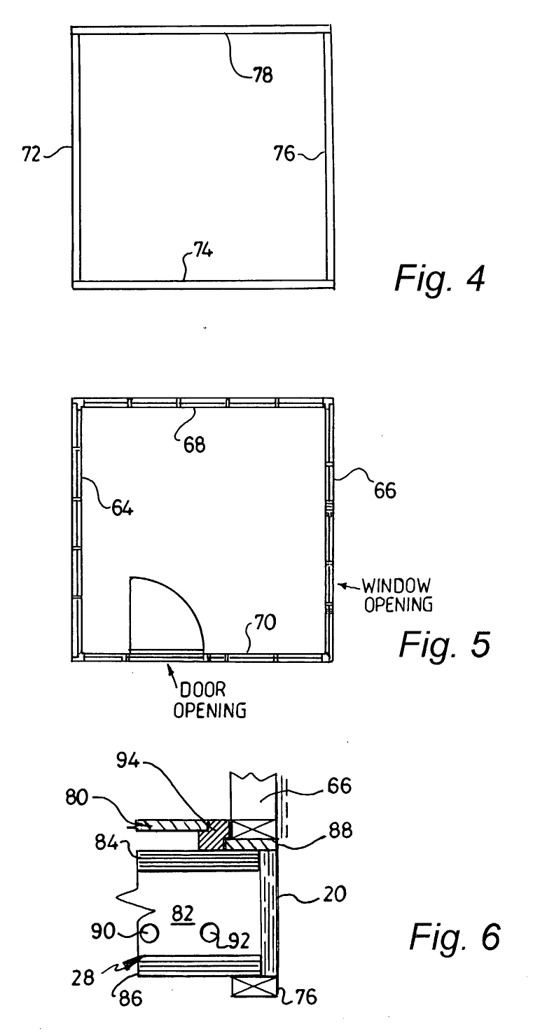

FIG. 4 is a perpendicular view of the reinforcing ring used in FIG. 3, and

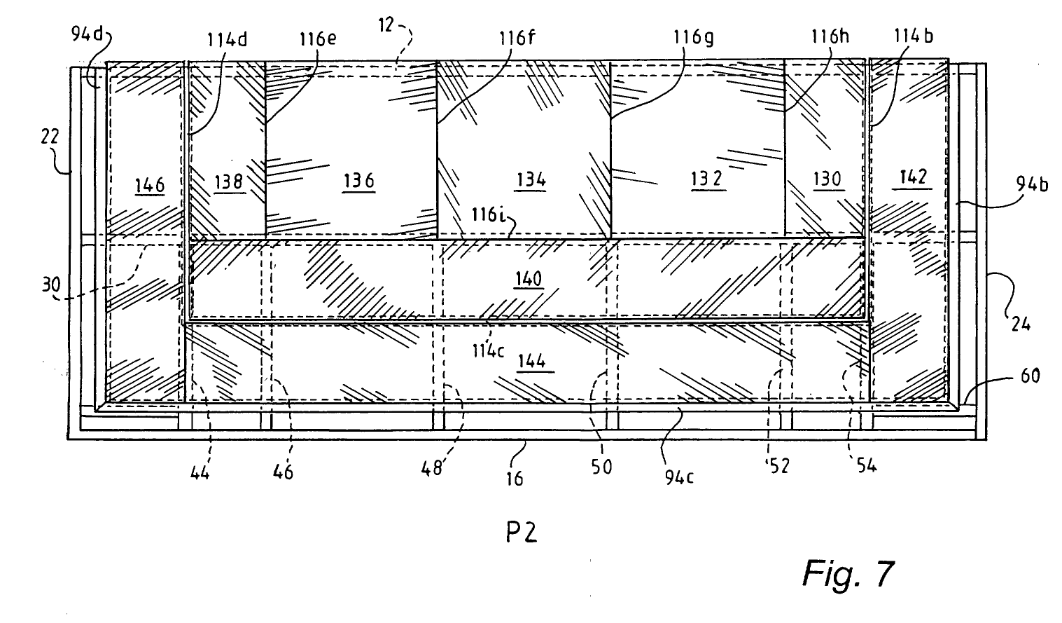

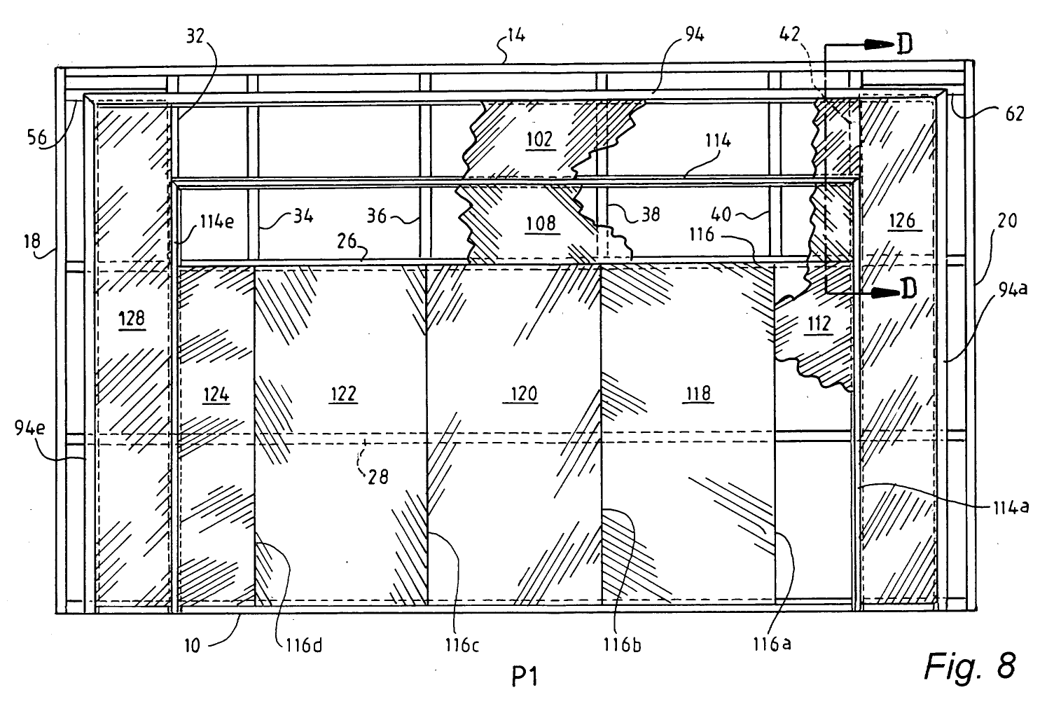

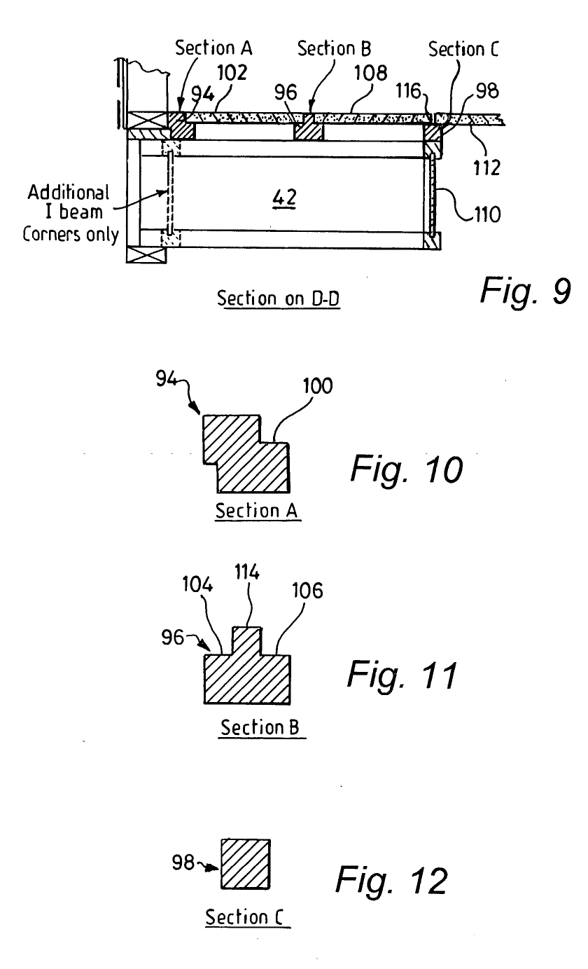

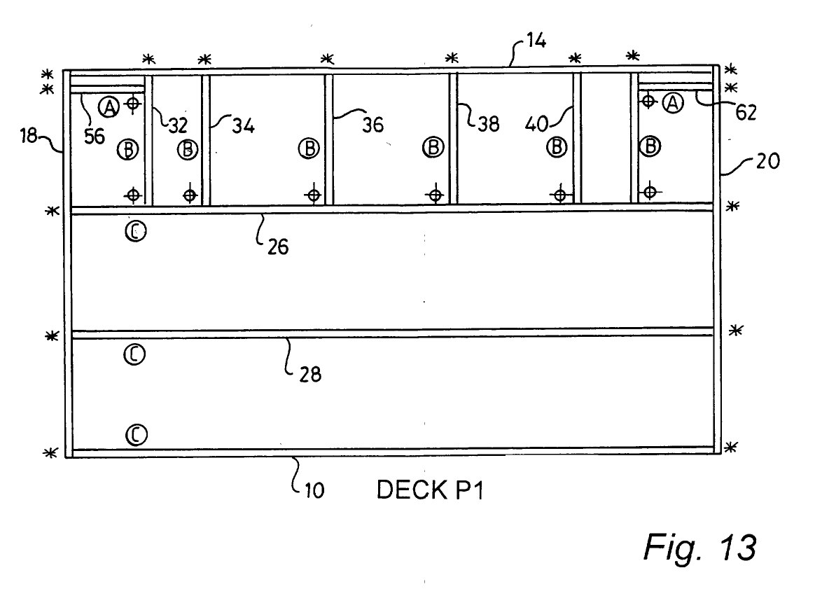

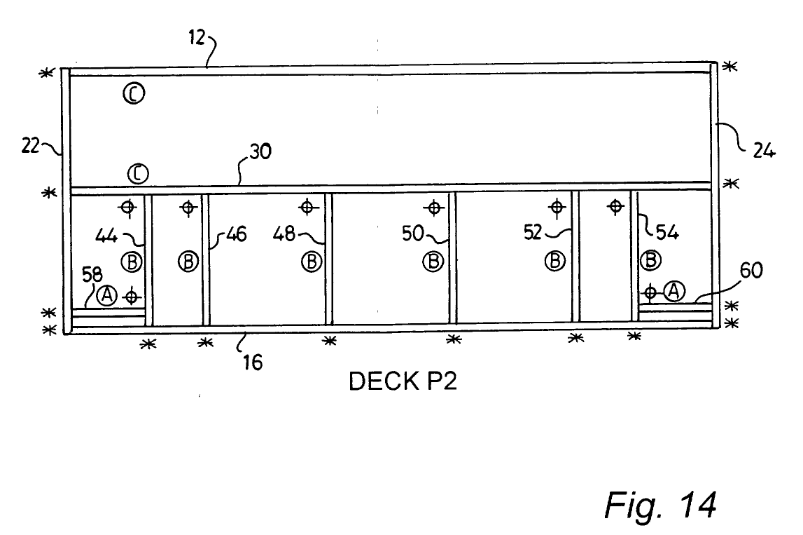

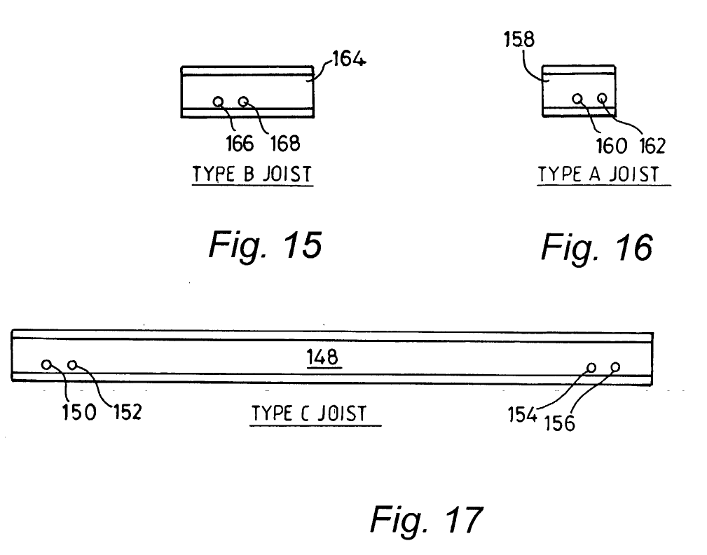

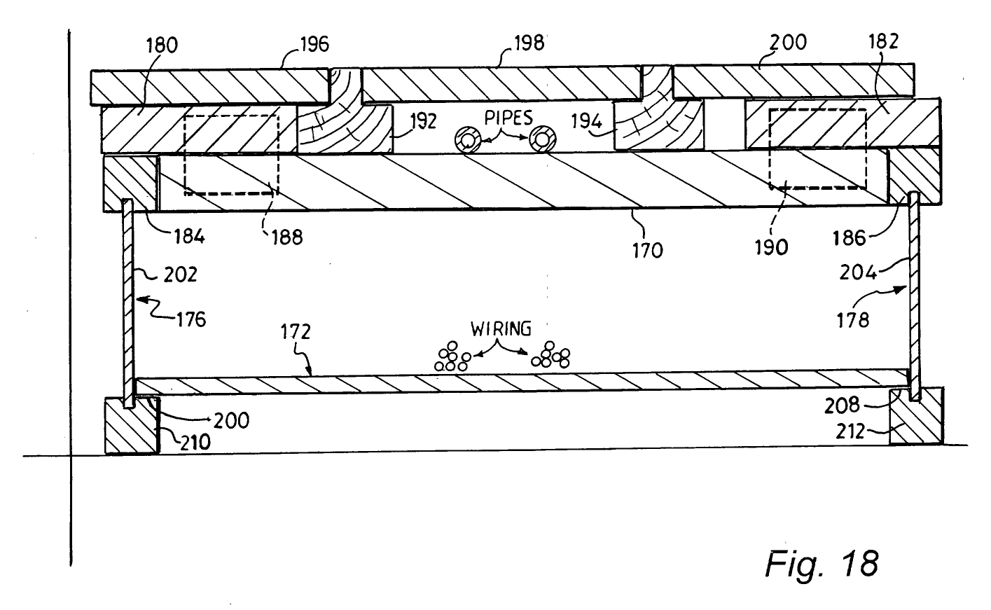

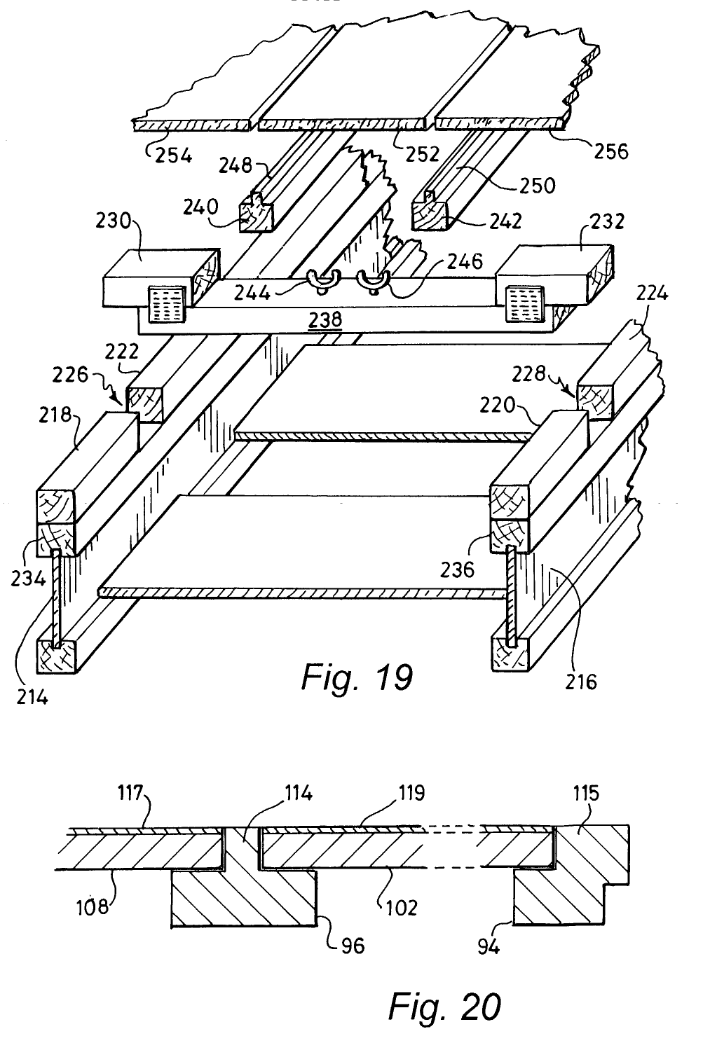

FIGS. 5A and 5B are two views of an alternative design of channel member for securing one I-beam joist to another in accordance with the invention.

### DETAILED DESCRIPTION OF FIGURES

As shown in FIG. 1 a first timber I-beam 10 is to be butt-jointed to a second (transverse) timber I-beam 12. Each I-beam is formed from a relatively thin web 14, (16) and upper and lower rails 18, 20 (22, 24).

A channel member 26 having side cheeks 28, 30 and a bridging base 32 is provided for effecting the joint. The side cheeks 28, 30 are each pre-formed (as by drilling or punching) with three holes—those in side cheek 30 being visible in FIG. 1 and being denoted by reference numerals 34, 36, 38.

The holes in the two side cheeks 28, 30 are aligned so that bolts can be passed through each pair of holes.

In order to secure the channel member 26 to the web 14, three similar holes 35, 37, 39 are formed in the web. The holes 34, 36, 38 in the channel member may serve as a template.

The gap between the internal faces of the side-cheeks 28, 38 is such that the web 14 is a close fit (if not a tight fit) therebetween.

The base 32 is secured to the transverse web 16 by means of three thread studs 40, 42, 44 and three corresponding holes 46, 48, 50 which are pre-formed at the correct position along the length of 16, as by drilling.

After pushing the web 16 onto the studs the web is secured by means of nuts and washers generally designated 52.

Tightening up the screws on the studs 46, 48 etc. will secure the web 16 securely to the base 32 of the channel member 26 as shown in FIG. 2.

The upper and lower rails 18, 20 of I-beam 10 are to advantage cut back to leave a tongue 54 of the web 14 protruding beyond the ends of the rails, as is seen in FIG. 1. This tongue will rest against the inside of the base 32 and create a better joint between the web and the channel member 26.

If the web 16 needs to be reinforced to resist deformation due to bending where the studs 40, 42, etc. protrude therethrough, a larger opening may be formed for each stud, and a dished metal shear ring 56 (see FIG. 4) can be push fitted therein with the rim of the ring 56 overlying the web material around the opening. One such shear ring can be provided for each stud.

The rear of the ring 56 will then abut the rear of the base 32 of the channel member 56 as shown in FIG. 3.

A similar rigid internal reinforcement (not shown) may be provided for each of the holes 35, 37, 39, in which event the latter need to be enlarged to allow for the wall thickness of the internal reinforcement, which latter is typically formed from rigid plastics or metal.

An alternative channel member 58 is shown in FIGS. 5A and 5B, which avoids the need to cut back the upper and lower rails 18, 20 of beam 10. Here the gap between the end of the web 14 and the face of web 16 is bridged by re-entrant formations in the two plates 60, 62 making up member 58. These formations are designated 64, 66 respectively and are joined by welding, brazing, riveting or the like, so that the two re-entrant regions remain back to back. The extent of the re-entrancy is such as to equate to the overhang of flange 12 relative to web 16, less twice the thickness of the plates 60, 62.

The plates extend outwardly beyond the re-entrant regions to form fixing flanges 68, 70 which are bolted to the web 16. The web 14 is secured between the parallel sections of the plates 60, 62 by bolts.

The bolts employed to secure the fixing flanges 68, 70 may be replaced by studs welded or otherwise secured to and extending from the flanges.

1. A method of joining one end of a first timber I-beam to a side face of a transversely extending second similar timber I-beam, each I-beam comprising a web between parallel elongate upper and lower flanges, comprising the steps of:
1) fitting the web at the said one end of the first I-beam between two parallel spaced apart side cheeks of a rigid channel member,
2) securing the channel member to the first I-beam web by means of at least one through fastening,
3) forming a hole in the web of the second I-beam to receive a securing member adapted to join the channel member to the second I-beam,
4) fitting into the hole in the web of the second I-beam a dished shear ring so as to be a tight fit therein, the shear ring having a central opening through which the securing member is to protrude,
5) positioning the second I-beam relative to the channel member and fitting a securing member by pushing it through the shear ring in the hole in the second I-beam so that an end of the securing member protrudes beyond the shear ring, and
6) securing the two beams together by fitting a closure member to the protruding end of the securing member to clamp the shear ring to the web of the second beam and to the rear of the channel member attached to the web of the first beam, whereby the second I-beam web is held tightly against the channel member.

2. A method according to claim 1 wherein the channel member includes a bridging section and the securing member comprises at least one stud protruding therefrom but on the face thereof remote from the side cheeks.

3. A method according to claim 2 wherein the stud extends in line with the web of the first I-beam when the joining member is secured thereto.

4. A method according to claim 2 wherein the through fastening is a bolt.

5. A method according to claim 1 further comprising the step of cutting back each of the upper and lower flanges of the first beam so that the ends of the flanges of the first beam are no longer aligned with the end of the web, and the latter extends beyond the cut-back end faces of the upper and lower flanges thereof, in order to improve the fit between the end of the first beam and the side of the second beam.

6. A method according to claim 5 wherein the amount by which the flanges are cut back is commensurate with the overhang of the corresponding flanges of the second beam relative to the web of the latter, less an amount equal to at least the thickness of the bridging base section of the channel member.

7. A method according to claim 1 wherein the side cheeks of the channel member include openings and the through-fastening is pushed through an opening in the web.

8. A according to claim 7, wherein openings in the side cheeks of the channel member are employed as a template for forming a hole in the web of an I-beam to be fitted therebetween.

9. A channel section I-beam joining member securable to the web of a first timber I-beam at one end thereof comprising two parallel spaced apart side-cheeks joined by a bridging section which together form the channel section, and at least one stud protruding from the bridging section on the face opposite that from which the side-cheeks extend, so that when fitted to the web the stud protrudes away from the end of the beam in line with the web thereof to be received in an opening in the web of a second timber I-beam located transversely to the end of the first I-beam, for joining the second I-beam to the first.

10. A channel member according to claim 9 further comprising a closure device fitted to the stud after the latter has been fitted through a hole in the second I-beam.

11. A joining member according to claim 9 wherein the height of the side cheeks of the channel section is commensurate with the distance between the upper and lower rails of the first beam, so that when fitted thereto the channel section is a snug fit therebetween.

12. A joining member according to claim 9 wherein the channel section is formed by two parallel plates spaced apart so as to receive the web of the first I-beam as a close fit therebetween, each plate including a re-entrant region formed by bending the plate, the two re-entrant regions being joined back to back so that the two plates form an integral assembly, wherein, beyond the back to back re-entrant regions, the plates extend outwardly to form fixing flanges for securing to the web of the second beam, the back to back joined re-entrant regions constituting a bridge between the two plates, and a spacer which bridges the gap between the end of the web of the first beam and the face of the web of the second bam, created by the laterally protruding rails top and bottom of the web of the second I-beam.

13. A joining member according to claim 12 wherein studs extend from the fixing flanges to pass through holes in the second I-beam web, for securing the fixing flanges thereto.

14. A joining member according to claim 13 further comprising a closure device fitted to the studs after the latter have been fitted through holes in the web of the second I-beam.

15. A joining member according to claim 12 wherein the flanges include holes, and holes in the second I-beam web are aligned with the holes in the flanges, to allow bolts to be passed therethrough to secure the web to the flanges.

16. A joining member according to claim 12 wherein the height of the side cheeks of the channel section is commensurate with the distance between the upper and lower rails of the first beam, so that when fitted thereto the channel section of the joining member is a snug fit therebetween.

17. A joining member according to claim 9, wherein the side cheeks of the channel section are formed with pairs of aligned holes and similar holes are formed through the web of the first I-beam, which align with the holes in the side cheeks when the web is fitted therebetween, and fastenings are pushed through the aligned holes whereby the web of the first I-beam is secured to and between the side cheeks of the joining member.
